(19) United States
(12) Patent Application Publication
(10) Pub. No.: US 2019/0090314 A1
(43) Pub. Date: Mar. 21, 2019

(54) REMOVABLE WINDOW STRIP FOR A WINDSHIELD

(71) Applicant: John Posey, Wichita, KS (US)

(72) Inventor: John Posey, Wichita, KS (US)

(21) Appl. No.: 15/708,528

(22) Filed: Sep. 19, 2017

(51) Int. Cl. H05B 3/84; B60R 16/03

(52) U.S. Cl. CPC H05B 3/84; B60R 16/03

(57) ABSTRACT

A window strip for application on a windshield that includes: an elongated strip; a heating element within the elongated strip; a plurality of wires extending from one end of the elongated strip; and power plug at the distal end of the plurality of wires. The power plug is adapted for placement into a DC power outlet. The elongated strip may also include an adhesive means adapted to attach the strip to a dashboard.

### BACKGROUND OF THE INVENTION

### Field of Invention

The present invention relates to a removable window strip that is applied to the inside surface of a windshield.

### Description of Related Art

Windshields provide visibility for motor vehicles during operation. Windshields normally surround the entire vehicle with principally a front and rear windshield but also side windshields are available to provide side views of the vehicle and assist with mirrors that provide rear view for the vehicle. It is essentially critical to have a reasonable view out of each windshield. This requirement is particularly important for the front windshield since this is the primary windshield used by the driver. The front windshield is further equipped with windshield wipers that wipe various types of precipitation from the windshield and heaters are provided to heat the windshield to provide defrosting action for the windshield. Further defrosters are typically installed in the windshield to provide defrosting capability. In certain extreme conditions, the actual windshield wipers may become frozen to the windshields, and therefore incapable of operating. This frozen condition causes a difficult problem and can be time consuming to resolve if appropriate measures aren't taken to prevent such an incident. One way to address this problem is to provide some type of heating mechanism placed on the windshield that could thaw or quickly warm up the wipers for use.

### SUMMARY OF THE INVENTION

The present invention relates to a window strip for application on a windshield that includes: an elongated strip; a heating element within the elongated strip; a plurality of wires extending from one end of the elongated strip; and power plug at the distal end of the plurality of wires. The power plug is adapted for placement into a DC power outlet. The elongated strip may also include an adhesive means adapted to attach the strip to a dashboard.

### BRIEF DESCRIPTION OF DRAWINGS

FIG. 1 depicts a window strip in accordance with the present invention.

### DETAILED DESCRIPTION

The present invention relates to a window strip applied across a dashboard of the motor vehicle. The window strip provides radiant heat that is sufficient to warm the inner surface of the windshield. This warming effect therefore defrosts any windshield wipers that may be frozen in extreme cold weather. The window strip is principally used prior to operating the vehicle but also can be used while the vehicle is in operation to maintain a certain level of heat on the inside surface of the windshield.

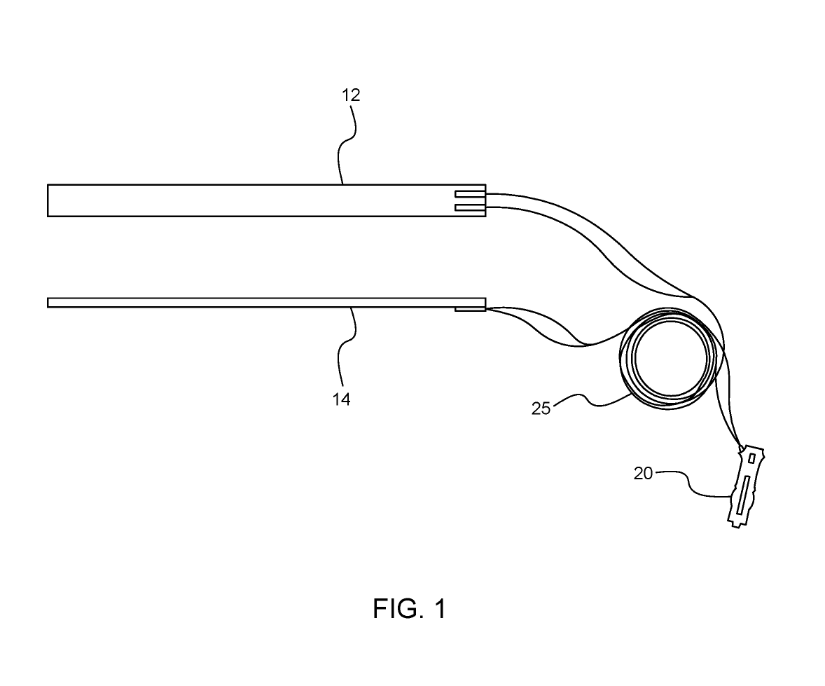

In reference to FIG. 1, a window Strip 12 is depicted. The strip 12 is shown in two positions: One showing the first side of the strip 12, position 14 shows the top side of the strip 12. The strip 12 is generally elongated and includes a heating element within the strip 12. A series of wires extends from the elongated strip 12 and provides a connection to power via a power plug 20 at the distal end of wiring 25. This particular arrangement enables the user to connect the plug 20 into a DC outlet such as a cigarette lighter or DC outlet of a motor vehicle. This arrangement allows the strip 12 to receive power from the vehicle's power system and activate the heating elements within the elongated strip provided. This strip 12 aids in keeping the windshield warm and defrosting any frozen conditions that may have occurred while the vehicle was parked.

Preferably the strip 12 provides repeated use on an inner surface of a windshield. An adhesive is provided on one side of the strip 12 to adhere the strip 12 to the windshield. The adhesive requires high heat resistant properties, such as an epoxy, silicone, UV curable or sodium silicate based coatings. The heating aspects of the strip 12 may include specific temperature settings such as a hi temperature or low temperature setting. Further, the heat may gradually increase and decrease once the windshield surface temperature reaches a predetermined temperature.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A window strip for application on a windshield comprising:
a. an elongated strip;
b. a heating element within the elongated strip;
c. a plurality of wires extending from one end of the elongated strip; and
d. power plug at the distal end of the plurality of wires.

2. The window strip according to claim 1, where the power plug is adapted for placement into a DC power outlet.

3. The window strip according to claim 1, where the elongated strip includes an adhesive means adapted to attach to a windshield.
